(19) United States
(12) Patent Application Publication
(10) Pub. No.: US 2015/0011666 A1
(43) Pub. Date: Jan. 8, 2015

(54) SYSTEMS AND METHODS FOR MANUFACTURING FOAM PARTS

(71) Applicant: JOHNSON CONTROLS TECHNOLOGY COMPANY, Holland, MI (US)

(72) Inventor: James Thomas McEvoy, Howell, MI (US)

(21) Appl. No.: 14/371,631

(22) PCT Filed: Jan. 9, 2013
(86) PCT No.: PCT/US2013/020771

§ 371 Date: Jul. 10, 2014

Related U.S. Application Data
(60) Provisional application No. 61/586,578, filed on Jan. 13, 2012.

(51) Int. Cl. B29C 44/34; B29C 44/12; C08G 18/06; B29C 44/58

(52) U.S. Cl. CPC B29C 44/3415; B29C 44/58; B29C 44/12; C08G 18/06; B29K 2075/00
USPC 521/170; 425/174.4; 264/415

(57) ABSTRACT

This disclosure relates generally to molded cellular foam parts and, more specifically, to methods of manufacturing cellular polyurethane foam parts. In an embodiment, a polymer production system includes an energy source configured to provide activation energy to a foam formulation to produce a foam part. The system further includes a polymeric mold configured to contain the foam formulation within a mold cavity during the manufacture of the foam part. Furthermore, the mold is configured to not substantially interact with the activation energy that traverses the mold during the manufacture of the foam part. The system also includes a semi-permanent surface coating disposed on a surface of the mold cavity that is configured to facilitate release of the foam part from the mold cavity.

### CROSS REFERENCE TO RELATED APPLICATIONS

This application claims priority from and the benefit of U.S. Provisional Application Ser. No. 61/586,578, entitled “SYSTEMS AND METHODS FOR MANUFACTURING FOAM PARTS,” filed Jan. 13, 2012, which is hereby incorporated by reference in its entirety for all purposes.

### BACKGROUND

This disclosure relates generally to molded polyurethane parts and, more specifically, to methods for manufacturing cellular polyurethane foam parts.

Polymeric materials, such as cellular foams, are widely used to make various parts in consumer goods, including foam seating, padding, sealants, gaskets, and so forth. During the manufacture of foam parts, foam precursors in a foam formulation may react with one another inside of a mold that imparts the desired shape to the resulting foam. For example, when polyurethane foam parts are manufactured and molded, an isocyanate precursor and a polyol precursor (e.g., a polyol precursor blend) may be combined within a mold, and the mold may subsequently be heated to overcome the activation energy barrier for the precursors to react (e.g., polymerize, cross-link, etc.). Additionally, to further facilitate these reactions, a catalyst may be provided to manufacture such parts in a cost effective manner. For example, during production of a foam part, a blowing agent (e.g., water) may cause the mixture may foam (i.e., form the cellular structure) and expand to fill the interior of the mold cavity (e.g., using a gas such as carbon dioxide), thereby assuming the shape of the cavity of the mold. Other materials may also be provided to enhance foaming of the mixture. Once cured, the foam object (e.g., a seat cushion) may be removed from the mold and used (e.g., within a seat). For certain processes, a foam part may be further cured (e.g., approximately 1 to 96 hours) to evaporate any residual catalyst and to drive the foam forming reactions to completion.

Traditional methods of manufacturing foam parts can consume large amounts of energy, consuming tens of billions of BTUs of heat each year. Generally speaking, a substantial amount of energy may be consumed in heating a mold throughout the entire production process, including periods when no foam formulation is present within the mold (e.g., when prepping the production line or between foam parts), which may represent approximately 30% to 50% of production time. Furthermore, traditional methods of manufacturing foam parts may also produce a high volume of volatile organic chemicals (VOCs) (e.g., aldehydes, amines, or similar chemicals), as environmentally deleterious byproducts of the manufacturing process. For example, certain catalysts or other components of traditional foam formulations may volatilize and/or decompose to release one or more VOCs (e.g., formaldehyde, aniline, or similar compound) during production of the foam part as well as during curing (e.g., for approximately 170 hours after production). These VOCs may pose environmental problems as well as a safety concerns for the foam manufacturer, often requiring substantial ventilation to maintain compliance with government regulations. Furthermore, as a general trend, many industries that consume foam parts, such as the automotive and transportation-related industries (e.g., consuming parts for cars, airplanes, trains, buses, motorcycles, etc.) are moving toward incorporating lighter, thinner foam parts into vehicles to improve fuel efficiency. Therefore, it may be desirable to produce foam parts having reduced weight that are still able to provide acceptable properties (e.g., static and dynamic comfort, durability, thermal airflow, etc.) for the desired application.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure includes embodiments directed toward polymeric or composite molds having permanent or semi-permanent surface coatings used in the production of cellular foams. One embodiment relates to a polymer production system. The polymer production system includes an energy source configured to provide activation energy to a foam formulation to produce a foam part. The system further includes a polymeric mold configured to contain the foam formulation within a mold cavity during the manufacture of the foam part. Furthermore, the mold is configured to not substantially interact with the activation energy that traverses the mold during the manufacture of the foam part. The system may also include a semipermanent surface coating disposed on a surface of the mold cavity that is configured to facilitate release of the foam part from the mold cavity.

Another embodiment relates to a mold. The mold has a base material including one or more polymeric materials substantially transparent to one or more of induction heating, microwave heating, or infrared (IR) heating supplied from outside the mold to activate a foam formulation contained within the mold during production of a molded foam part. The mold also includes a surface coating disposed on a surface of the base material to facilitate the release of the molded foam part from the mold.

Another embodiment relates to a formulation for manufacturing a polyurethane foam part. The formulation includes a polyol precursor formulation, an isocyanate precursor, and an activator. The activator includes one or more metallic particles configured to respond to one or more of induction, microwave irradiation, or infrared (IR) irradiation to activate one or more chemical reactions between at least the polyol precursor formulation and the isocyanate precursor while manufacturing the polyurethane foam part.

Another embodiment relates to a method of producing a foam part. The method includes disposing a foam formulation inside of a mold cavity of a composite mold, in which the mold cavity has a shape and includes a fluorinated surface coating. The method also includes directly heating the foam formulation disposed inside of the mold cavity to form the foam part in the shape of the mold cavity without directly heating the mold. The method further includes curing the foam part in the mold cavity before removing the foam part from the mold cavity.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an embodiment of a foam part production system, in accordance with aspects of the present technique;

FIG. 2 is a process flow diagram illustrating an embodiment of a process for producing a foam part, in accordance with aspects of the present technique;

FIG. 3 is a perspective side-view of an embodiment of a mold, in accordance with aspects of the present technique;

FIG. 4 is a perspective top-view of the mold illustrated in FIG. 3, in accordance with aspects of the present technique;

FIG. 5 is a cross-sectional view taken within line 5-5 of FIG. 1 illustrating the surface of the mold embodiment of FIG. 1; and

FIG. 6 is a cross-sectional view of the foam part manufactured in accordance with aspects of the present technique.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As set forth above, the disclosed embodiments relate to the production of foam parts in a relatively efficient and environmentally friendly manner compared to traditional foam molding techniques. Using a mold that is substantially transparent to (i.e., substantially invisible to) the method of heating the foam formulation (e.g., induction heating or heating using visible or non-visible wavelengths of radiation, such as infrared (IR) light, ultraviolet (UV) light, or microwaves), the disclosed embodiments enable a considerable amount of energy to be conserved during the manufacture of a foam part. Additionally, the presently disclosed mold embodiments include a permanent or semi-permanent surface coating (e.g., waxes, fluoropolymers, silicon dioxide, titanium dioxide, or similar surface coating) to facilitate the release of the manufactured foam part from the mold. The present disclosure also includes foam formulation embodiments having activators (e.g., metallic flakes and/or metal-coated ceramic beads) that may facilitate the efficient activation of the foam-forming reactions, further reducing the energy cost per foam part produced. Additionally, the presently disclosed techniques may allow the production of foam parts having a lower minimum foam thickness (e.g., 10 mm) and/or a lower minimum part thickness (e.g., 20 mm) compared to other methods of production. Furthermore, the disclosed formulations and techniques may generally produce fewer VOC byproducts during the production of foam parts compared to traditional foam molding techniques. Accordingly, the presently disclosed techniques enable the production of foam parts at considerably lower production and environmental cost.

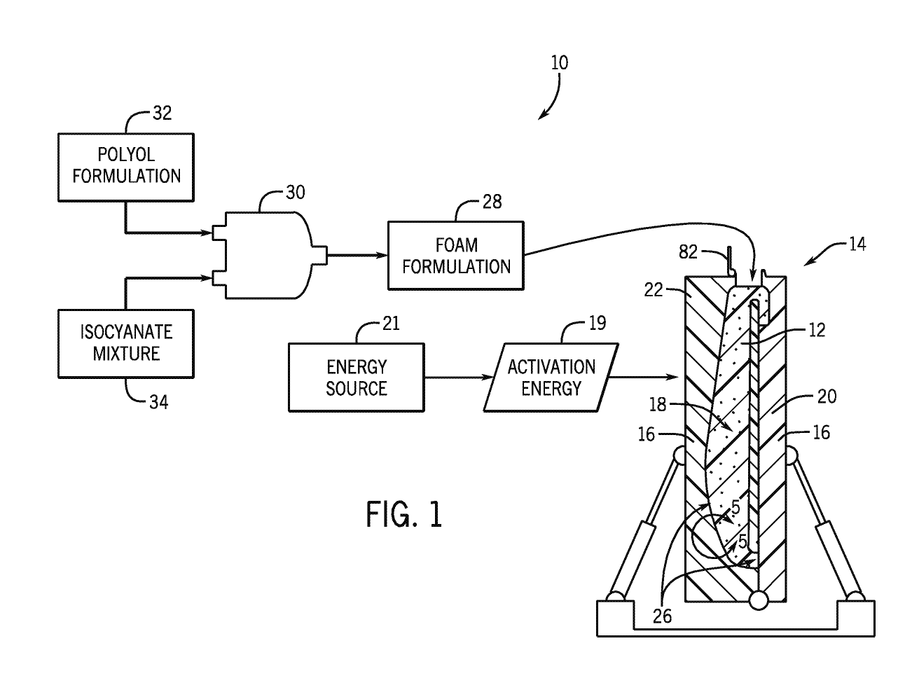

With the foregoing in mind, FIG. 1 illustrates a schematic overview of a system 10 for preparing a foam part 12 (e.g., a polyurethane seat cushion) within a mold 14. The mold 14 includes a base material 16 and a mold cavity 18 formed (e.g., machined) into the base material 16. The mold cavity 18 generally imparts shape to the foam part 12 as the foam is produced by the chemical reactions discussed below. The base material 16 of the mold 14 may be made from a polymeric material (e.g., expanded polyethylene (EPE), high-density polyethylene (HDPE), low-density polyethylene (LDPE), expanded polypropylene (EPP), expanded acrylonitrile butadiene styrene (ABS-E), polystyrene, polysulfone, nylon, polyvinyl chloride, or similar polymeric material), or a composite of several polymeric materials (e.g., a plastic composite, an epoxy composite, or similar composite), capable of providing mechanical stability for the foam produced within the cavity 18. Indeed, the base material 16 may include any hard, durable polymeric material in accordance with other aspects of the present technique presented below. Additionally, while the mold 14 illustrated in FIG. 11 includes two pieces 20 and 22 that come together to form the mold cavity 18, it should be noted that in certain embodiments, the mold cavity 18 may be formed from a single piece, or from more than two pieces, each piece having an inner surface 26 for contacting the foam part 12. Moreover, the number of pieces (e.g., pieces 20 and 22) that form the mold cavity 18 may depend on the particular shape and/or size of the foam part 12 to be produced and the specific method used for producing the foam part 12. Furthermore, as discussed below, the inner surface 26 of the mold cavity 18 may have one or more permanent or semi-permanent surface coatings (e.g., a fluorinated polymer layer) that may facilitate the release of the foam part 12 from the mold cavity 18 once the part 12 has been manufactured.

Furthermore, the base material 16 is substantially transparent to the manner in which activation energy 19 (e.g., an external stimulus or energy input that is provided by an energy source 21) is delivered to the mold cavity 18 to produce the foam part 12. That is, the base material 16 of the mold 14 may not significantly respond to (e.g., absorb, scatter, or otherwise significantly interfere with) an activation energy 19 that traverses the mold 14 to activate (e.g., heat) a foam formulation 28 contained within the mold cavity 18. For example, in certain embodiments, the activation energy 19 may be in the form of IR light (e.g., supplied by an IR energy source 21), and the base material 16 of the mold 14 may be substantially transparent to IR light such that the IR light supplied to the outside of the mold 14 reaches the mold cavity 18 with approximately the same intensity. By further example, in certain embodiments, the activation energy 19 may be provided in the form of microwave irradiation (e.g., supplied by a microwave-generating energy source 21), and the base material 16 of the mold 14 may generally allow the microwaves to reach the contents of the mold cavity 18 relatively unabated. By still further example, in certain embodiments, the activation energy 19 may be provided in the form of induction heating of one or more metal surfaces present within the contents of the mold cavity 18 (e.g., via a radio frequency (RF) induction heating energy source 21), and the base material 16 may be substantially transparent to this electromagnetic induction (e.g., electromagnetic field and/or RF radiation) such that the base material 16 is not directly heated by the energy traversing the mold 14.

During operation of the system 10, various materials are mixed to ultimately produce a tram formulation 28, which is a reactive mixture capable of forming the foam part 12 inside the mold 14 when subjected to suitable polymerization conditions (e.g., heating caused by the activation energy 19). In the present context, the foam part 12 is a polyurethane foam part manufactured from a foam formulation 28. Accordingly, the foam formulation 28 is produced from materials capable of forming repeating carbamate linkages (i.e., a polyurethane) and urea linkages from water and isocyanate. In the illustrated embodiment, the foam formulation 28 is produced by mixing, in a mixing head 30, a polyol formulation 32 and an isocyanate mixture 34. However, it will be appreciated that in certain embodiments, the foam formulation 28 may be produced upon mixing the polyol formulation 32 and the isocyanate mixture 34 directly in the mold cavity 18. That is, as discussed below, in certain embodiments, the mold 14 may he designed for closed-pour or injection molding, wherein the mold 14 may remain substantially closed during the formation of the foam part 12.

The polyol formulation 32 may include, among other reactants, polyhydroxyl compounds (i.e., small molecules or polymers having more than one hydroxyl unit including polyols and copolymer polyols). Table 1 below provides example components of a polyol formulation 28 and their respective amounts. It may be appreciated that, for the various formulation embodiments represented in Table 1, other factors (e.g., cure time and heat input) may vary.

TABLE 1
Example Polyol Formulation

| Component | Amount (parts per hundred polyol) |
|---|---|
| Base Polyol (no solids) | 0-100 |
| Copolymer Polyol (with solids) | 0-100 |
| Water (Blowing Agent) | 0-9 |
| Crosslinker | 0-6 |
| Metal Activators | 0.001-5 |
| Surfactant | 0.01-12.5 |

For example, the polyol formulation 32 may include polyether polyol synthetic resins commercially available from Bayer Materials Science, LLC. The polyol formulation 32 may also include a blowing agent (e.g., water), a cross-linker, a surfactant, and other additives (e.g., cell openers, stabilizers). The polyol formulation 32 may further include other polymeric materials, such as copolymer materials that are configured to impart certain physical properties to the foam part 12. One example of such a copolymer is a styrene-acrylonitirile (SAN) copolymer. In Table 1, water is provided as an example of a blowing agent; however, in certain embodiments, it should be appreciated that a certain degree of foaming may occur from the isocyanate precursor and polyol precursor without the addition of the blowing agent, for example, to form an elastomer. It may be appreciated that formulation embodiments lacking the addition of water may provide a high-density elastomer material (e.g., suitable for gaskets) and may allow for a rapid or flash curing of the elastomer. Furthermore, it may be appreciated that the particular copolymers, crosslinkers, and/or surfactants of Table 1 that are discussed herein are not intended to be limiting. Rather, in certain embodiments, these components may be substituted for one or more copolymers, crosslinkers and/or surfactants known to those of skill in the art and compatible with the present approach.

Further, in certain embodiments, one or more metal activators configured to facilitate polyurethane production (i.e., reaction between the hydroxyl groups of the polyol formulation 32 and the isocyanate groups of the isocyanate mixture 34) may be used, and may be a part of the polyol formulation 32. For example, in certain embodiments, the polyol formulation 32 may include one or more metal surfaces that may lower the activation energy barrier of the form formulation 28 and/or respond to the activation energy 19 to heat and activate the foam formulation 28. In certain embodiments, the polyol formulation 32 may include small metal flakes and/or metal-coated ceramic beads as activators within the foam formulation. For example, the polyol formulation 32 may include flakes of metal (e.g., bismuth, cadmium, zinc, cobalt, iron, steel, and/or other similar metals) ranging from nanometers to millimeters in size. For example, in certain embodiments, the polyol formulation may include zinc flakes of 200 μm or less. By further example, the polyol formulation 32 may include ceramic beads (e.g., alumina, silica, titania, zirconia, or similar ceramic beads) ranging from nanometers to millimeters in diameter and coated with a metal (e.g., bismuth, cadmium, zinc, cobalt, iron, steel, or other similar metal). Additionally, in certain embodiments, the metal activators may include iron, steel, or similar metals from recycled sources. Also, in certain embodiments, these metallic activators may be metal-coated cenospheres or glass beads measuring in the nanometer size regime. Furthermore, in certain embodiments, certain organometals (e.g., organobismuth and/or organozinc compounds), or other similar materials may, additionally or alternatively, be employed.

It should be appreciated that the one or more metal activators may take the place of a traditional amine-based catalyst (e.g., aniline) to facilitate the formation of the foam part 12. It should further be appreciated that, through the use of the one or more metal activators, present embodiments of the foam formulation 28 may take advantage of unique chemistries and/or materials that are generally inaccessible or problematic for traditional foam manufacturing processes. For example, since the presently disclosed embodiments of foam formulation 28 may not incorporate amine-based catalysts, the foam formulation 28 may enable the use of non-petroleum-based or partially non-petroleum-based blended polyol formulations 32 that may not be compatible with amine-based catalysts. That is, non-petroleum-based polyol formulations 32 may contain residual acids and therefore, an exorbitant amount of amine-based catalyst might be needed in order to promote the foam forming reactions in traditional processes. In contrast, these residual acids may have little to no effect on the ability of the one or more metal activators to promote the formation of the foam part 12 for the presently disclosed foam manufacturing process. Accordingly, the presently disclosed technique enables the use of foam formulations 28 having one or more non-traditional materials (e.g., recycled metal or polymer materials, recycled or naturally occurring oils, etc.) to provide further cost advantages.

In certain embodiments, the one or more metal activators (e.g., the metal flakes and/or metal coated ceramic beads) may specifically respond to the activation energy 19 that is applied to the foam formulation 28 during the manufacture of the foam part 12. That is, the dimensions and materials of the activators may be selected such that when, for example, induction heating is used to supply the activation energy 19 to the foam formulation 28 disposed within the mold cavity 18, the one or more activators present within the foam formulation 28 may specifically be heated by the electromagnetic induction (e.g., RF signals) and, subsequently, heat the surrounding foam formulation 28. By further example, when microwave radiation is used to deliver the activation energy 19 the foam formulation 28 within the mold cavity 18, it may specifically be the activator (e.g., a surface of the metal flake or metal-coated ceramic bead) that substantially absorbs the microwave radiation and, subsequently, heats the remainder of the foam formulation 28. Accordingly, by controlling the concentration and position of these activators and/or controlling the delivery of activation energy 19 to the foam formulation 28 within the mold cavity 18, the foam formulation 28 may be heated in a non-uniform fashion, resulting in a foam part 12 having multiple densities and hardnesses. As discussed in detail below, for certain embodiments a permanent or semi-permanent surface coating (e.g., a fluorinated polymer layer) having a non-uniform thickness may be utilized such that different portions of the foam part 12 may release from the mold cavity 18 at a different temperature. Furthermore, it should be appreciated that, unlike other foam formulations, in certain embodiments, the foam formulation 28 may generally remain inert (i.e., not begin to substantially react) until the activation energy 19 is applied, providing greater control the foam production process.

The isocyanate mixture 34, which is reacted with the polyol formulation 32 in the mold 14, may include one or more different polyisocyanate compounds. Examples of such compounds include methylene diphenyl diisocyanate (MDI), toluene diisocyanate (TDI), or other such compounds having two or more isocyanate groups. The polyisocyanate compounds may also include prepolymers or polymers having an average of two or more isocyanate groups per molecule. The particular polyisocyanate compounds used may depend on the desired end use (i.e., the desired physical properties) of the foam part 12. It should be noted that the concentration of the isocyanate species should generally correspond to the concentrations of the polyols and water listed in Table 1. Accordingly, in certain embodiments, the concentration of the isocyanate species may range from between 2.4 and 100 parts per hundred depending on the amount of polyol and water used.

As mentioned, present embodiments generally employ one or more permanent or semi-permanent surface coatings to provide suitable lubricity for removal of the foam parts 12 from the mold cavity 18 while also providing a relatively chemically inert surface (e.g., does not substantially interact with foam formulation 28 or other chemicals present in the local environment). In certain embodiments, traditional surface coatings may be used, including, for example, solvent-based wax (e.g., from water or mineral spirits), varnish makers and printers (VM&P) naphtha, or combinations of water and organic solvents, which should work well with both metallic and polymer molds.

Furthermore, in certain embodiments, the surface coatings may generally provide an extended number of cycles compared to traditional, commonly-employed wax-based release agents. For example, in certain embodiments, a single surface coating may be utilized, though it should be noted that any suitable number of coatings may be employed. In certain embodiments, the one or more permanent or semi-permanent surface coatings may be a fluorinated polymer layer. For example, the surface coatings may, for example, include polytetrafluoroethylene (PTFE) or another fluoropolymer, or a combination of materials (e.g., a combination of metal and plastic) such as nickel-PTFE. In other embodiments, one or more the permanent or semi-permanent surface coating may include silicon dioxide, titanium dioxide, or other similar oxide-based surface coatings. It should generally be noted that, like the base material 16 of the mold 14, the one or more surface coatings may be substantially transparent to the method of supplying activation energy 19 to the foam formulation 28 within the mold cavity 18. That is, the one or more surface coatings may not significantly interact with (e.g., absorb, scatter, or otherwise diminish or interfere with) the activation energy 19 that traverses the mold 14 and the one or more surface coatings before reaching the foam formulation 28 contained within.

Furthermore, in certain embodiments, the one or more surface coatings (e.g., a fluorinated polymer layer) may generally have a non-uniform thickness. For example, the thickness of a non-uniform fluorinated polymer layer may correspond to a desired release temperature at a particular portion of the mold 14. That is, in certain embodiments, a thicker fluorinated polymer layer may generally result in a lower temperature release, while a thicker fluorinated polymer layer may generally result in a higher temperature release of the multi-density foam part 12 from the mold cavity 18. Therefore, in such embodiments, the non-uniform fluorinated polymer layer may facilitate the manufacture and the release of the multi-density foam part 12 at non-uniform local temperatures.

In certain embodiments, the one or more surface coatings may be deposited on the inner surface 26 of the mold cavity 18 using chemical vapor deposition (CVD). Furthermore, the one or more surface coatings may be applied such that the thickness of the coatings may be controlled. For example, a fluorinated polymer (e.g., PTFE) may be deposited onto the inner surface 26 of the mold cavity 18 using CVD and one or more masks to limit the amount of polymer deposited on specific portions of the mold cavity 18. Accordingly, a variable-thickness surface coating (e.g., a fluoropolymer layer) may be deposited over the inner surface 26 of the mold cavity 18 in a controlled manner. Generally, any suitable thickness of the one or more coatings is presently contemplated. For example, in one embodiment, the thickness of the one or more surface coatings may range from 1 to 20 μm. In other embodiments, the thickness of the one or more surface coatings may range between approximately 1 and 100 μm, such as between approximately 1 and 90 μm, 1 and 75 μm, 5 and 30 μm, or 7 and 15 μm, depending on the desired release temperature. By further example, in other embodiments, the one or more surface coatings may have a uniform thickness (e.g., 25 μm) over the entirety of the mold cavity 18. It should be further noted that the surface coatings may be selected based on certain desirable properties as well as other considerations, including but not limited to, metal activator selection, the temperature of the foam production process, other materials in the foam formulation 28, the type of polyurethane foam to be produced, and the desired surface processes for releasing the foam object 12 from the mold 14.

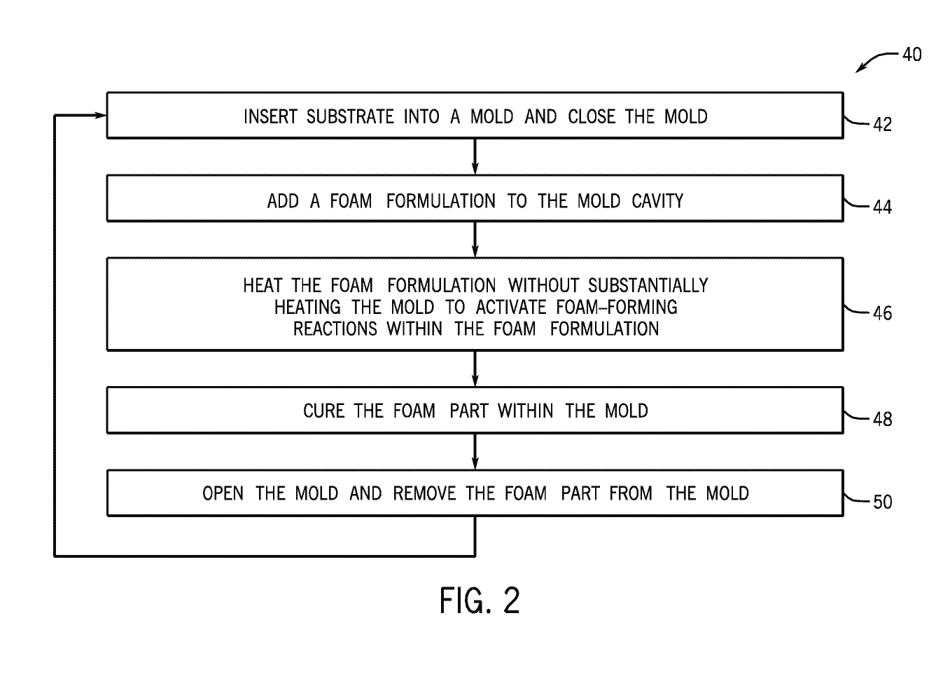

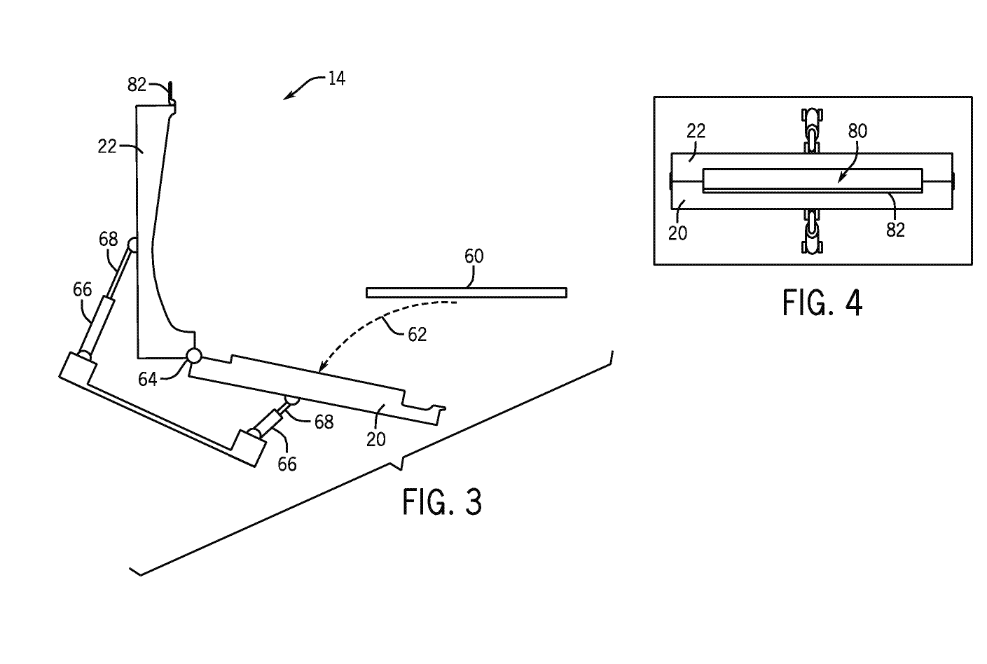

FIG. 2 illustrates an embodiment of a process 40 for producing a foam part 12 in accordance with aspects of the present technique. The process 40 begins with the insertion (block 42) of a substrate into the open mold 14 prior to closing the mold 14. Turning briefly to FIG. 3, an example of the mold 14 in its open form is illustrated. More specifically, FIG. 3 illustrates a substrate 60, discussed in detail below, as it is being inserted 62 into the open mold 14. As illustrated, the mold 14 may include one or more hinging portions 64 coupling two or more pieces (e.g., piece 20 or 22) of the mold 14 together such that the mold 14 may be opened and closed about the hinged portion 64. In certain embodiments, the hinged portion 64 of the mold 14 may be constructed from the same base material 16 or a different base material 16 (e.g., a different plastic, a composite, or other material), than the remainder of the mold 14. Furthermore, in certain embodiments, the mold 14 may also include one or more cylinders 66 (e.g., hydraulic fluid or gas compression cylinders) which may be used to actuate one or more rods 68 (e.g., constructed of a hard, high-durability polymeric material, like nylon) to facilitate the opening or closing of the mold 14. Like the hinged portion 64, these one or more cylinders 66 and their corresponding rods 68 may also be constructed from the same base material 16 or a different base material 16 than the remainder of the mold 14. In certain embodiments, the hinged portion 64, the one or more cylinders 66, and/or the one or more rods 68 may be made from a base material 16 substantially transparent to the activation energy 19 that traverses the mold 14 to reach the foam formulation 28 within the mold cavity 18.

Generally speaking, the substrate 60 may be a polymeric or composite substrate that may be incorporated into a foam part 12 in order to impart desired properties to the foam part 12. The substrate 60 may generally be a polymer substrate (e.g., expanded polyethylene, expanded polystyrene, or any suitable composite thereof) that may be inserted, illustrated as arrow 62, into the open mold 14 prior to the manufacture of the foam part 12. Accordingly, once the foam part 12 has been manufactured, the substrate 60 may provide one or more layers within the resulting foam part 12, and these layers may have certain physical properties (e.g., density, hardness, flexibility, compressibility, or similar physical properties) which may affect the resulting physical properties of the foam part 12. Additionally, in certain embodiments, the substrate 60 may be automatically inserted into the open mold 14 (e.g., via an automated process control system) and the mold 14 may be automatically closed prior to production of the foam part 12. It should be noted that, in certain embodiments, the substrate 60 may not be used. In such embodiments, the acts represented by block 42 may be skipped and resulting foam part 12 may be entirely made of foam rather than having a polymer layer.

Returning to FIG. 2, once the substrate 60 has been inserted into the open mold 14 and the mold 14 has been closed, the foam formulation 28 may be added (block 44) to the closed mold 14. Generally speaking, the foam formulation 28 may be added to the mold 14 in any suitable manner. In certain embodiments, the foam formulation 28 may be introduced into the mold cavity 18 using a closed-pour or injection molding technique. Turning to FIG. 4, a perspective view of the top of the closed mold 14 is illustrated. For the mold 14 illustrated in FIG. 4, the two pieces 20 and 22 of the mold 14 have been brought into contact with one another such that only a small gap 80 is present at the top of the mold 14 (e.g., for the introduction of the foam formulation 28 into the mold cavity 18). Furthermore, in certain embodiments, one or more pieces 20 or 22 of the mold 14 may include a door 82 which may be closed to seal the mold cavity 18 prior to the production of the foam part 12. For embodiments utilizing injection molding techniques, in addition to or in lieu of the gap 80, one or more ports may be present at various portions of the mold 14 that may be used to inject the foam formulation 28 into the mold cavity 18. Additionally, in certain embodiments the mold 14 may be positioned upright (e.g., at 90° or perpendicular relative to the floor) as the foam formulation 28 is added to the mold cavity 18 while, in other embodiments, the mold 14 may be positioned at any angle between approximately 5° and 175° or between approximately 75° and 135° (relative to the floor), based on the flow and design of the foam part 12.

Returning to FIG. 2, after the foam formulation 28 has been added to the mold cavity 18, the foam formulation 28 may be heated (block 46) in order to activate foam forming reactions within the foam formulation 28. Moreover, the method of heating the foam formulation 28 (i.e., the method of providing activation energy 19), does not substantially heat the mold 14. That is, the base material 16 and surface coatings applied to the mold cavity 18 are generally transparent to the activation energy 19 that is supplied to the foam formulation 28. It should be appreciated that, while the mold 14 may not substantially interact with the activation energy 19 as it traverses the mold 14, a small portion of the activation energy 19 may be inadvertently lost. Furthermore, it should be appreciated that, while the mold 14 may not directly interact with the activation energy 19 as it traverses the mold 14 to reach the foam formulation 28, the mold cavity 18 may be indirectly heated by the foam formulation 28 as the formulation is directly heated by the activation energy 19. In other words, any heating experienced by the mold 14 will generally be a result of heat transfer from the heated foam formulation 28 to the mold 14. It should be appreciated that, in contrast to other foam molding techniques, the disclosed embodiments utilize methods of heating in which the mold 14 itself is not directly heated by an external source to deliver heat to the foam formulation 28.

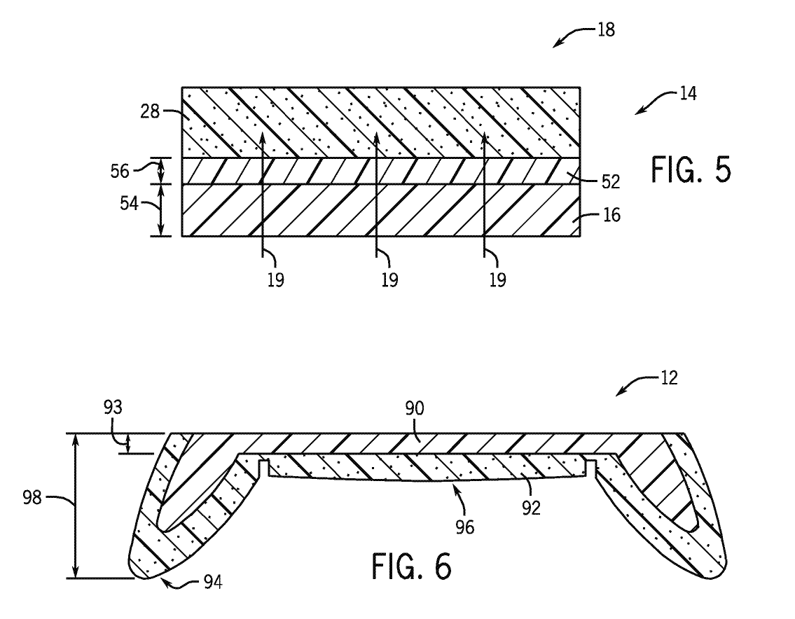

To further illustrate the inner surface 26 of the mold cavity 18, FIG. 5 is a cross-sectional view (taken along line 5-5 of FIG. 1) illustrating a portion of an embodiment of the mold 14. In the illustrated cross-section, a surface coating 52 (e.g., PTFE) deposited on the base material 16 of the mold cavity 18, and the foam formulation 28 is disposed within the mold cavity 18. It should be noted that with respect to FIG. 5, proportions have been emphasized for demonstrative purposes and, therefore, the surface coating 52 and the base material 16 are not necessarily drawn to the same relative scale. While any suitable thickness is presently contemplated, in certain embodiments, the base material 16 of the mold 14 may have a thickness 54 of approximately 1 inch. In certain embodiments, the thickness 54 may range from 0.10 in. to 8 in. Furthermore, in the illustrated embodiment, the thickness 56 of the surface coating 52 is approximately 20 μm. In other embodiments, the thickness 56 of the surface coating 52 may range from approximately 1 μm to approximately 40 μm. Furthermore, as mentioned, neither the base material 16, nor the surface coating 52 may significantly interact with the activation energy 19 that traverses the base material 16 and the surface coating 52 before reaching the foam formulation 18 located within the mold cavity 18. Additionally, while a surface coating thickness 56 is illustrated in FIG. 5, it should be noted that, in other embodiments, a surface coating 52 having multiple thicknesses (e.g., 15 μm, 20 μm, and 25 μm), with gradual transitional thicknesses or dramatic steps between, may also be utilized.

Once the foam formulation 28 has been heated to activate the foam forming reactions, the foam part 12 may begin to form within the mold cavity 18. Generally speaking, certain of the disclosed embodiments employ a foam formulation 28 having one or more activators that lower the activation energy barrier. That is, through the use of the one or more activators, the formulation 28 consumes less activation energy before the exothermic foam forming reactions make the reaction energetically self-sufficient. Additionally, the activators may convert the activation energy 19 (e.g., IR light, microwave radiation, RF induction, or the like) into the heat within the foam formulation 28 to overcome this activation energy barrier. Accordingly, the present foam production process 40 may only expend a suitable quantity of activation energy 19 to initiate exothermic foam-forming reactions, unlike traditional foam forming techniques in which the mold 14 and the foam formulation 28 would be heated (e.g., to 170° F.) throughout the manufacture of the foam part 12.

For example, in an embodiment, microwave activation energy 19 may be used to heat the foam formulation 28 to a temperature less than 100° F. (e.g., slightly above room temperature) in order to activate the foam forming reactions. In certain embodiments, the amount of activation energy 19 supplied to the foam formulation 28 may be based on the environment (e.g., temperature, humidity, barometric pressure etc.) within the plant, the foam formulation 28, or certain desirable properties (e.g., hardness, durability, density, etc.) of the foam part. Subsequently, the heat generated by the initial foam forming reactions may drive subsequent foam forming reactions, and process may become energetically self-sufficient until the foam precursors have been consumed. It should be appreciated that supplying an initial activation energy 19 (e.g., via energy source 21) directly to the foam formulation provides a substantial energy savings compared to heating the entire mold 14 and foam formulation 28 throughout the manufacture of the foam part 12. Indeed, many traditional production lines maintain the temperature of the mold (e.g., a metal mold) at the desired reaction temperature (e.g., 170° F.) throughout the entire foam production process, including periods when the mold is empty (e.g., when prepping the molds to begin production and/or between foam parts), which releases heat into the plant environment while driving up energy costs. Furthermore, it should be appreciated that since the activation energy 19 is directly provided to a foam formulation 28 contained within the mold cavity 18, the polymeric mold 14 may actually behave as an insulator, preventing the heat produced by the activation energy 19, as well as any heat generated from exothermic processes during foam formation, from easily escaping into the surrounding plant environment. Accordingly, the presently disclosed transparency of the mold 14 to the activation energy 19, the exothermic foam forming reactions, and the thermally insulating properties of the mold 14 may work in conjunction to provide significant energy savings throughout the foam production process.

Returning again to FIG. 2, once the foam part 12 has been formed, it may be cured (block 48) within the mold 14 prior to removal. That is, the foam part 12 may be allowed sufficient time to complete the foam forming reactions and to generally solidify into the shape of the mold cavity 18. Using the foam formulation 28 and the various methods of supplying activation energy 19 described above, the presently disclosed embodiments enable faster curing times for foam parts 12 than traditional foam production processes. For example, a traditional foam production processes may allow approximately 4 min. for a foam part 12 to cure before it is removed from the mold. In contrast, a similar foam part 12 manufactured according to the presently disclosed process 40 may cure in under 3 min (e.g., approximately 30% faster). Generally speaking, the faster curing of the disclosed technique may, at least in part, due to the delivery of the activation energy into the foam formulation compared to a traditional surface-based heating method (i.e., using a heated mold to heat the foam formulation). That is, for traditional surface-based heating methods, as the foam begins to form at the surface of the mold cavity, the generally insulating properties of the foam may somewhat inhibit the transfer of additional heat to the core of the foam formulation in order to cure the foam core of the part. In contrast, the presently disclosed technique enables the delivery of the activation energy 19 directly to the foam formulation 28 (e.g., the entire thickness of the foam formulation 28) such that the foam formulation 28 may be more uniformly heated throughout the curing of the foam part 12. However, in certain embodiments, the activation energy 19 (e.g., the intensity, frequency, magnitude of the activation energy 19) and/or the foam formulation 28 (e.g., the concentration of the one or more activators) may intentionally be varied in order to produced localized, non-uniform heating when producing multi-density foam parts, as discussed below.

Once the foam part 12 has cured, the mold 14 may be opened (block 50) and the foam part 12 may be removed from the mold cavity 18. Generally speaking, once the foam part 12 has been removed from the mold cavity 18, a new substrate may be inserted into the mold (block 42) and the process 40 may be repeated. Turning to FIG. 6, an example of a foam part 12 in accordance with aspects of the present technique is illustrated. As mentioned, the foam part 12 may generally include a substrate layer 90 having a foam layer 92 attached. For example, the substrate layer 90 may be polymer (e.g., expanded polyethylene, expanded polystyrene, or any suitable composite thereof) formed from the polymer substrate 60 that was inserted into the mold 14 prior to the production of the foam part 12 (e.g., block 42). The illustrated foam part 12 includes a substrate layer having a thickness 93 of approximately 10 mm. In certain embodiments, the substrate 60 may undergo one or more chemical or physical transformations (e.g., chemical reactions with the foam layer 92, melting, cross-linking or hardening through one or more chemical reactions) during the formation of the foam part 12 in order to form the substrate layer 90.

Additionally, the illustrated foam part 12 of FIG. 6 includes some thicker foam portions 94 and some thinner foam portions 96 (e.g., based on the shape of the mold cavity 18). The illustrated foam part 12, for example, has a maximum thickness 98 of approximately 60 mm, including the substrate layer 90 and the foam where 92. Furthermore, in certain embodiments, the foam part 12 may additionally be a multi-density, multi-hardness foam part 12, and the density of the foam part 12 at certain portions (e.g., portion 96) may be substantially different from the density at another portion (e.g., portion 94) of the multi-density foam part 12. Additionally, in certain embodiments, the foam part 12 may be between approximately 35% and 75% polyurethane foam, with the remaining portion of the foam part 12 being the substrate layer 90. Accordingly, the presently disclosed techniques may allow the production of thinner foam parts 12 (e.g., having a lower minimum foam thickness of approximately 10 mm or less and/or a total part thickness of approximately 20 mm or less) compared to other methods of production in which the lower minimum foam thickness may be significantly larger (e.g., approximately 40 mm or more). Furthermore, in certain embodiments, the foam part 12 may be between 10 and 20 mm thick and include between 5% to 95% polyurethane with a natural fiber construction interwoven. For transportation-related industries, thinner, lighter foam parts 12 generally offer advantages in terms of fuel efficiency as every component on-board contributes to the weight of the vehicle. Indeed, as vehicles move away from petroleum-based power, lighter foam parts having thinner cross-sections continue to gain appeal.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A polymer production system, comprising:
an energy source configured to provide an activation energy to a foam formulation to produce a foam part;
a polymeric mold configured to contain the foam formulation within a mold cavity during the manufacture of the foam part, wherein the polymeric mold is configured to not substantially interact with the activation energy that traverses the polymeric mold during the manufacture of the foam part; and
a semi-permanent surface coating disposed on a surface of the mold cavity, wherein the semi-permanent polymer coating is configured to facilitate release of the foam part from the mold cavity.

2. The polymer production system of claim 1, wherein the energy source comprises an induction energy source, a microwave energy source, and infrared (IR) energy source, or any combination thereof.

3. The polymer production system of claim 1, wherein the energy source is configured to heat the foam formulation to between approximately 70° F. and approximately 100° F. to provide the activation energy to the foam formulation.

4. The polymer production system of claim 3, wherein the energy source is configured to heat the foam formulation in a non-uniform fashion during the production of the foam part.

5. The polymer production system of claim 1, wherein the foam formulation comprises one or more metal activators configured to receive the activation energy provided by the energy source to heat the foam formulation.

6. The polymer production system of claim 5, wherein the one or more metal activators are configured to receive the activation energy in the form of induction, microwave radiation, or IR radiation and convert the activation energy into heat within the foam formulation.

7. The polymer production system of claim 5, wherein the one or more metal activators comprise one or more metal particles comprising bismuth, cadmium, zinc, cobalt, iron, steel, or any combination thereof.

8. The polymer production system of claim 7, wherein the one or more metal particles comprise metal flakes, metal-coated ceramic beads, or any combination thereof.

9. The polymer production system of claim 7, wherein the one or more metal activators comprise one or more metal particles from recycled metal sources.

10. The polymer production system of claim 1, wherein the polymeric mold comprises polyethylene, polypropylene, acrylonitrile butadiene styrene, polystyrene, polyvinyl chloride, polysulphone, or any combination or composite thereof.

11. The polymer production system of claim 10, wherein the polymeric mold comprises expanded high-density polyethylene, low-density polyethylene, expanded polypropylene, expanded acrylonitrile butadiene styrene, or any combination or composite thereof.

12. The polymer production system of claim 1, wherein the semi-permanent surface coating comprises polytetrafluoroethylene (PTFE), silicon dioxide, titanium dioxide, or any combination thereof.

13. The polymer production system of claim 1, wherein the semi-permanent surface coating has a non-uniform thickness over the mold cavity.

14. The polymer production system of claim 1, wherein the foam part comprises a polyurethane foam part.

15. The polymer production system of claim 1, wherein the foam part comprises a polyurethane foam part having a polymer substrate layer.

16. The polymer production system of claim 15, wherein the polymer substrate layer comprises expanded polyethylene, expanded polystyrene, or any combination thereof.

17. A mold comprising:
a base material comprising one or more polymeric materials substantially transparent to one or more of induction heating, microwave heating, or infrared (IR) heating supplied from outside the mold to activate a foam formulation contained within the mold during production of a molded foam part; and
a surface coating disposed on a surface of the base material, wherein the surface coating is configured to facilitate the release of the molded foam part from the mold.

18. The mold of claim 17, wherein the base material comprises expanded high-density polyethylene, low-density polyethylene, expanded polypropylene, polysulfone, expanded acrylonitrile butadiene styrene, or any combination or composite thereof.

19. The mold of claim 17, wherein the surface coating is configured to be substantially transparent to one or more of induction heating, microwave heating, or infrared (IR) heating supplied from outside the mold to activate a foam formulation contained within the mold during production of a molded foam part.

20. The mold of claim 17, wherein the surface coating comprises polytetrafluoroethylene (PTFE), a silicon dioxide layer, a titanium dioxide layer, or any combination thereof.

21. The mold of claim 17, wherein the surface coating comprises two or more thicknesses, and wherein the two or more thicknesses are configured to provide two or more corresponding release temperatures for the molded foam part.

22. The mold of claim 17, wherein the molded foam part comprises a polyurethane molded foam part having a expanded polyethylene or expanded polystyrene substrate layer.

23. The mold of claim 17, wherein the foam formulation comprises one or more metal particles configured to be activated by one or more of induction heating, microwave heating, or infrared (IR) heating during production of the molded foam part.

24. The mold of claim 23, wherein the metal particles comprise metal flakes or metal-coated particles comprising one or more of bismuth, cadmium, zinc, cobalt, iron, or steel.

25. A formulation for manufacturing a polyurethane foam part, comprising:
a polyol precursor formulation;
an isocyanate precursor; and
an activator comprising one or more metallic particles configured to respond to one more of induction, microwave irradiation, or infrared (IR) irradiation to activate one or more chemical reactions between at least the polyol precursor formulation and the isocyanate precursor while manufacturing the polyurethane foam part.

26. The formulation of claim 25, wherein the polyol precursor formulation comprises polyether polyol synthetic resin, an oil from a non-petroleum source, or any combination thereof.

27. The formulation of claim 25, wherein the isocyanate precursor comprises methylene diphenyl diisocyanate (MDI), a MDI prepolymer, toluene diisocyanate (TDI), a TDI prepolymer, or any combination thereof.

28. The formulation of claim 25, wherein the polyol precursor formulation comprises one or more blowing agents, cross-linkers, surfactants, cell openers, stabilizers, or co-polymers.

29. The formulation of claim 25, wherein the one or more metallic particles range from approximately 10 μm to approximately 300 μm in size.

30. The formulation of claim 25, wherein the one or more metallic particles comprise metallic flakes of bismuth, cadmium, zinc, cobalt, iron, steel, or any combination thereof.

31. The formulation of claim 25, wherein the one or more metallic particles comprise ceramic beads coated with bismuth, cadmium, zinc, cobalt, iron, steel, or any combination thereof.

32. The formulation of claim 25, wherein the formulation is configured to be used in conjunction with a composite mold cavity having a semi-permanent, surface-bound fluorinated polymer coating.

33. A method of producing a foam part, comprising:
disposing a foam formulation inside of a mold cavity of a polymeric mold, wherein the mold cavity has a shape and includes a fluorinated surface coating;
directly heating the foam formulation disposed inside of the mold cavity to form the foam part in the shape of the mold cavity without directly heating the mold; and
curing the foam part in the mold cavity for a cure time before removing the foam part from the mold cavity.

34. The method of claim 33, comprising disposing a substrate into the mold cavity, wherein the substrate is incorporated into the foam part.

35. The method of claim 34, wherein the substrate comprises expanded polyethylene, expanded polystyrene, or any combination thereof.

36. The method of claim 34, wherein disposing the foam formulation comprises a closed-pour or injection of the foam formulation inside of the mold cavity.

37. The method of claim 34, wherein the fluorinated surface coating comprises PTFE.

38. The method of claim 34, wherein the fluorinated surface coating has at least two different thicknesses.

39. The method of claim 34, wherein the foam formulation comprises one or more metal surfaces configured to facilitate one or more chemical reactions to form the foam part.

40. The method of claim 34, wherein the one or more metal surfaces comprise flakes of a metal or particles coated with the metal, and wherein the metal comprises one or more of bismuth, cadmium, zinc, cobalt, iron, or steel.

41. The method of claim 34, wherein directly heating the foam formulation comprises directly heating the foam formulation using induction heating, microwave heating, infrared (IR) heating, or any combination thereof.

42. The method of claim 34, wherein directly heating the foam formulation comprises directly heating the foam formulation in a non-uniform manner to produce the foam part, and wherein the foam part has more than one density.

43. The method of claim 34, wherein directly heating the foam formulation comprises directly heating the foam formulation to between approximately 70° F. and approximately 100° F. without directly heating the mold cavity.

44. The method of claim 34, wherein the polymeric mold comprises expanded high-density polyethylene, tow-density polyethylene, expanded polypropylene, expanded acrylonitrile butadiene styrene, polysulfone, or any combination or composite thereof.

45. A foam part produced according to the method of claim 34.
